(19) United States
(12) Patent Application Publication
(10) Pub. No.: US 2015/0286616 A1
(43) Pub. Date: Oct. 8, 2015

(54) Method For Generating A Document Using An Electronic Clipboard

(71) Applicant: Ephox Corporation, Palo Alto, CA (US)

(72) Inventors: Ben Davey, San Francisco, CA (US); Damien Fitzpatrick, Queensland (AU); Andrew Herron, Queensland (AU)

(73) Assignee: Ephox Corporation, Palo Alto, CA (US)

(21) Appl. No.: 14/247,148

(22) Filed: Apr. 7, 2014

(51) Int. Cl. G06F 17/22; G06F 17/21

(52) U.S. Cl. CPC G06F 17/2264; G06F 17/212

(57) ABSTRACT

A disclosed method generates a document for display in a target application. Copies of the document are retrieved from an electronic clipboard, where the document copies are in multiple formats comprising a native format and a first foreign format. One or more objects from the retrieved document copy in the first foreign format are extracted. The retrieved document copy in the native format and the extracted objects are then merged. The merged document is then displayed in the target application.

### FIELD OF INVENTION

The disclosure relates to generating an electronic document, and, more particularly, to generating a merged document using multiple copies of a document from an electronic clipboard.

### BACKGROUND

As generally known, “copy-and-paste” and “cut-and-paste” functions provided by modern operating systems of a computing device (e.g., a server, a computer, a laptop, a tablet, a mobile phone, a smart watch, etc.) are useful to easily move or reproduce a selected document (or a portion of the document), including any text, images, and/or data in that selected document. When a copy or cut operation is performed, the operating system stores the copied or cut document in a region of system memory commonly referred to as the operating system clipboard. The operating system clipboard is available to any application program running on the computing device. The selected document can be transferred within a single application or between different applications via the operating system clipboard.

The operating system may fail to properly paste certain media content (e.g., images, videos, or other media content) from the operating system clipboard to a target application due to inaccessible references of the certain media content. This deficiency in the clipboard functionality impairs and limits the usefulness of browser-based document creation programs, webpage creation tools, and other software applications.

FIG. 1 illustrates a diagram for an operating system clipboard. When copying a selected document (or portion of the document, including any text, images, and/or other data) from a typical word processor document, the selected document is copied into an operating system clipboard 10 in a variety of document formats, including HyperText Markup Language (“HTML”), rich text format (“RTF”), a bitmap image file format (e.g., portable network graphics, “PNG”), and other document formats. Thus, the operating system clipboard 10 can comprise a document copy 12 in the HTML format, a document copy 14 in the RTF format, a document copy 16 in the PNG format, and one or more document copies 18 in other document formats. In the rich text format, any text, images, and other content of the selected document can be embedded within the document copy 14. In the HTML format, images and/or other media content are referenced by a file universal reference indicator (“URI”). Therefore, the document copy 12 in the HTML format will not have embedded images or other media content beyond text. This is problematic when the document copy 12 is pasted into a target application which may not be able to retrieve the file URI's.

FIG. 2 illustrates a diagram of the prior art for retrieving content from an operating system clipboard using a paste function. When a web browser receives a paste function call, only the document copy 12 in the native HTML format is retrieved from the operating system clipboard 10 to be pasted in the web browser. The pasted content 20 is in the native format for the web browser, i.e., the HTML format. However, image content (and/or other media content beyond text) is referenced within the document copy 12 by file URI pointers. In order for the web browser to retrieve that image content, the web browser must access locally stored image content in the respective computing device. Due to security settings of the respective computing device, the file URI pointers are generally not accessible by the web browser. When attempting to display the referenced image content in the web browser, an error is displayed rather than the referenced image content.

FIG. 3 illustrates a diagram where source content is pasted into a target application using a prior art pasting function. Selected source content 30 in a source application of a computing device can be cut (or copied) into an operating system clipboard of the computing device. The source content 30 comprises text 32, image 34, text 36, and image 38. The source content 30 is copied into the operating system clipboard in multiple document formats.

When a paste command is triggered, the source content 30 from the operating system clipboard can be pasted into a web browser, the targeted application in this example. The operating system will provide the source content 30 in the HTML format to the web browser since HTML is the native format of the web browser. A pasted content 40 can be the result of that paste command, as displayed in the web browser. The text 32 and 36 of the source content 30 are properly displayed in the pasted content 40 as text 42 and 46 since the source content 30 is in the native format as the web browser. The web browser cannot properly display the file references for the image 34 and the image 38 because the respective image content is not in an accessible location to the web browser. For instance, the web browser may not have the appropriate security permission to access files on the respective computing device. Thus, the web browser will return errors for inaccessible references 44 and 48 in the pasted content 40.

Therefore, there exists a need to provide new methods and systems for generating a document for a target application from an operating system clipboard, where selected content are properly displayed in the target application.

### SUMMARY OF INVENTION

Briefly, the disclosure relates to methods and systems for generating a document for display in a target application, comprising the steps of: retrieving document copies from an electronic clipboard, wherein the document copies are in multiple formats comprising a native format and a first foreign format; extracting one or more objects from the retrieved document copy in the first foreign format; merging the retrieved document copy in the native format and the extracted objects to generate a merged document; and displaying the merged document in the target application.

### DESCRIPTION OF THE DRAWINGS

The foregoing and other aspects of the disclosure can be better understood from the following detailed description of the embodiments when taken in conjunction with the accompanying drawings.

FIG. 1 illustrates a diagram for an operating system clipboard.

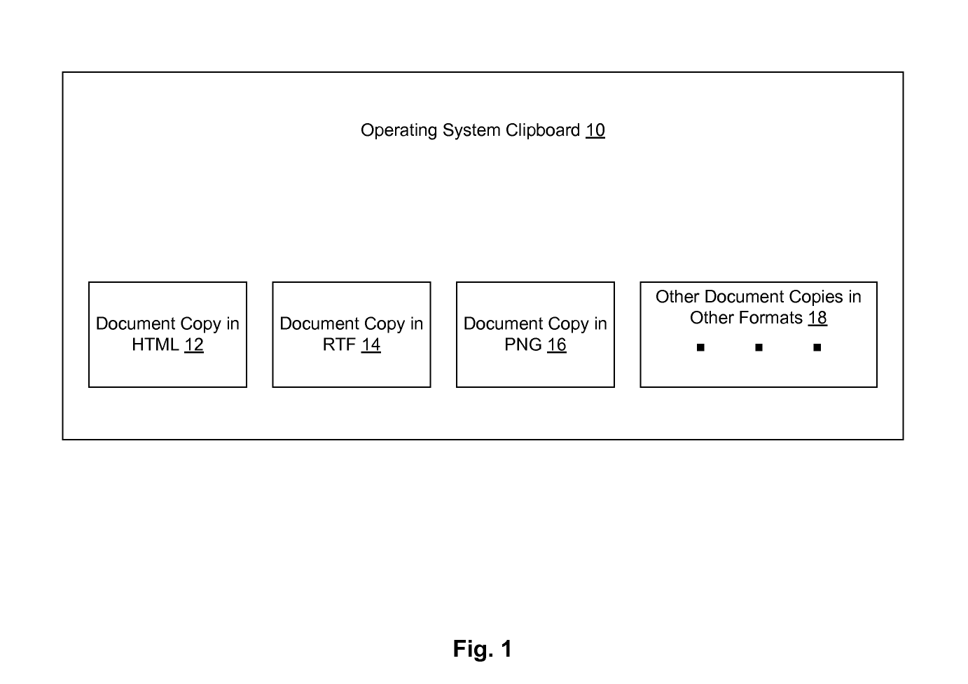

FIG. 2 illustrates a diagram of the prior art for retrieving content from an operating system clipboard using a paste function.

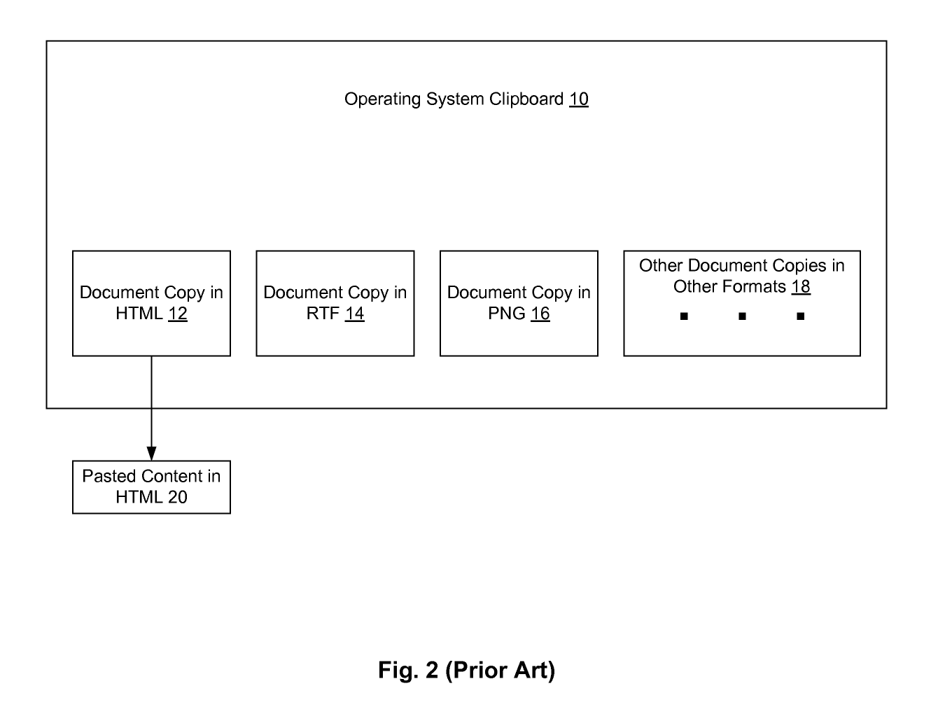

FIG. 3 illustrates a diagram where source content is pasted into a target application using a prior art pasting function.

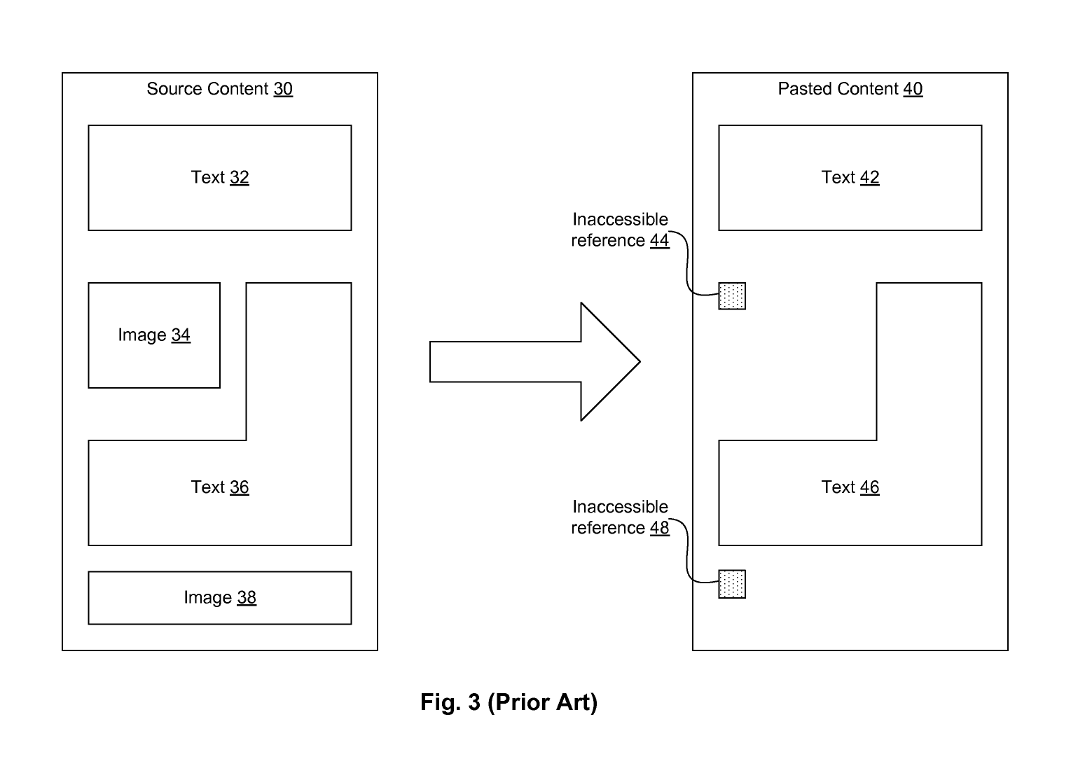

FIG. 4 illustrates a diagram for retrieving content from an operating system clipboard using document copies in multiple formats.

FIG. 5 illustrates a diagram of another embodiment for retrieving content from an operating system clipboard using document copies in multiple formats.

FIG. 6 illustrates a diagram where source content from an operating system clipboard is pasted to a target application.

FIG. 7 illustrates a flow chart for implementing a resource merger using an identifier correlation method.

FIG. 8 illustrates a flow chart for implementing a resource merger using a metadata correlation method.

FIG. 9 illustrates a flow chart for implementing a resource merger using an order correlation method.

FIG. 10 illustrates a flow chart for merging image content using image references from a native-formatted document copy and embedded content from a foreign-formatted document copy.

### DETAILED DESCRIPTION OF THE EMBODIMENTS

In the following detailed description of the embodiments, reference is made to the accompanying drawings, which form a part hereof, and in which is shown by way of illustration of specific embodiments in which the disclosure may be practiced.

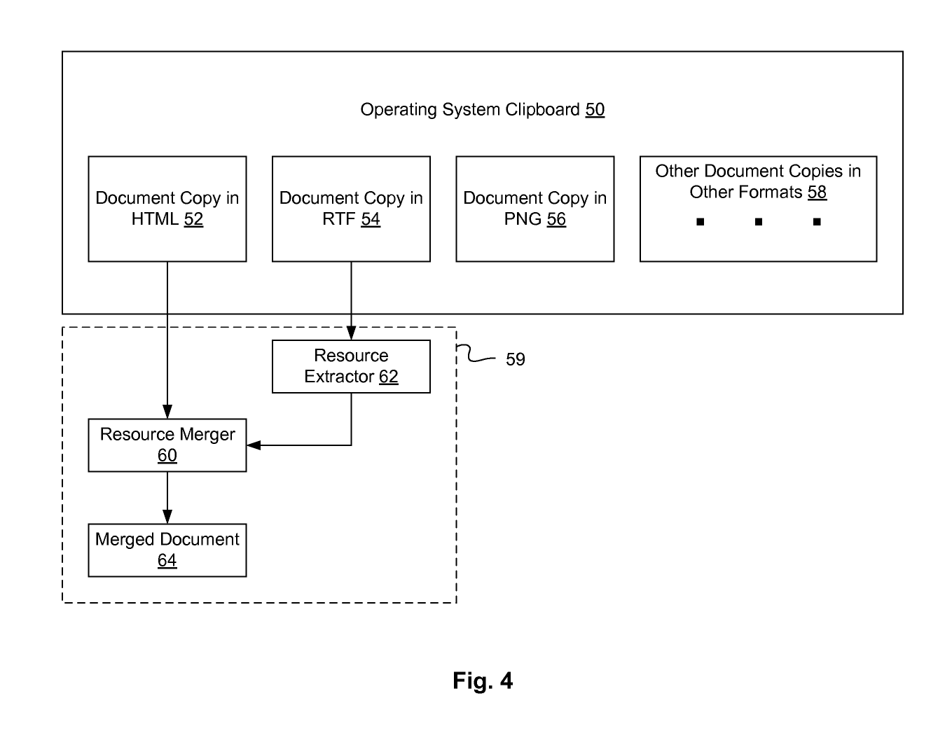

FIG. 4 illustrates a diagram for retrieving content from an operating system clipboard using document copies in multiple formats. Upon a copy command, a selected document (or a selected portion of a document) is copied to an operating system clipboard 50. The operating system clipboard 50 stores document copies of the selected document in multiple document formats, including a document copy 52 in the HTML format, a document copy 54 in the RTF format, a document copy 56 in the PNG format, and other document copies 58 in other document formats. It is understood that the document can be a selected portion of the document or the entire document. Furthermore, the contents of that selection can be text, images, videos, sounds, and/or any other types of digital content. To aid in the understanding of the disclosure, the term “document” can be used to refer to a portion of a document, an entire document, a portion of a file, or an entire file, including any text, images, video, sounds, webpages, and/or any other types of digital content within that document and/or file.

A receiver 59 for a target application (e.g., a web browser, web editing application, or other software application) can be granted access to the operating system clipboard 50 to retrieve a document copy in the native format of the target application. If the receiver 59 is for a web browser application, the native format can be the HTML format (and/or other web browsing formats). Other document formats that are not native format(s) to the target application can be referred to as foreign formats. The receiver 59 uses one or more of the document copies 54-58 and the document copy 52 in HTML format to generate a merged document 64. The merged document 64 can have images and other referenced media, including videos and audio, properly displayed in the target application since the media content from one or more of the document copies 54-58 can be merged with the document copy 52.

The receiver 59 comprises a resource merger 60 and a resource extractor 62. It is understood that the resource merger 60 and the resource extractor 62 can be implemented as one logical block or further subdivided as multiple logical blocks in accordance with the disclosure. To aid in the understanding of the disclosure, the specific function of the resource merger 60 and the resource extractor 62 are described in the disclosure. However, it is not meant to limit the disclosure to the resource merger 60 and the resource extractor 62 as described, but to also include other variations to a person having ordinary skill in the art based on the disclosure.

The resource extractor 62 functions to extract objects (including, images, audios, videos, other multimedia content, and/or other data) from one or more of the document copies 54-58 in the foreign document formats. The resource extractor 62 can also extract any descriptive metadata that surrounds the extracted objects in the one or more document copies 54-58. After determining if there's any metadata or extracted objects, the resource extractor 62 returns a list of resource descriptors for the document copies 54-58.

In this example, the resource extractor 62 extracts metadata and embedded image content from the document copy 54 in the RTF format. The extracted data is inputted to the resource merger 60. The resource merger 60 can identify non-retrievable content from the document copy 52 in the native format. In particular, resource descriptors (e.g., any URI pointers) in the document copy 52 can be identified as non-retrievable content. The resource merger converts the extracted image content from the document copy 54 to the HTML format, i.e., the native format for the web browser. The converted image content in the HTML format is then merged 60 at the corresponding resource descriptor locations in the document copy 52 to form the merged document 64. The merged document 64 can then be properly displayed in the target application.

The resource merger 60 correlates content from the document copy 52 in the HTML format (i.e., the native format of the web browser) and one or more of the document copies 54-58 in the foreign formats using various techniques, including an identifier (“ID”) correlation method, a metadata correlation method, an order correlation method, or other correlating methods for correlating resource descriptors with media content.

The ID correlation method correlates a unique ID token in the document copy 52 in the HTML format to corresponding embedded media content in the one or more document copies 54-58 in foreign formats. The metadata correlation method correlates width, height, file extension, and/or other media information for media content in the document copy 52 to corresponding embedded image content (and/or other media content) in the one or more document copies 54-58 in the foreign formats. The order correlation method correlates the URI pointer order in which the file URI pointers appear in the document copy 52 to one or more corresponding embedded image content in the one or more document copies 54-58 in the foreign formats. Thus, the URI pointer order can be used as an index pointer to the order of the embedded image content in the one or more document copies 54-58.

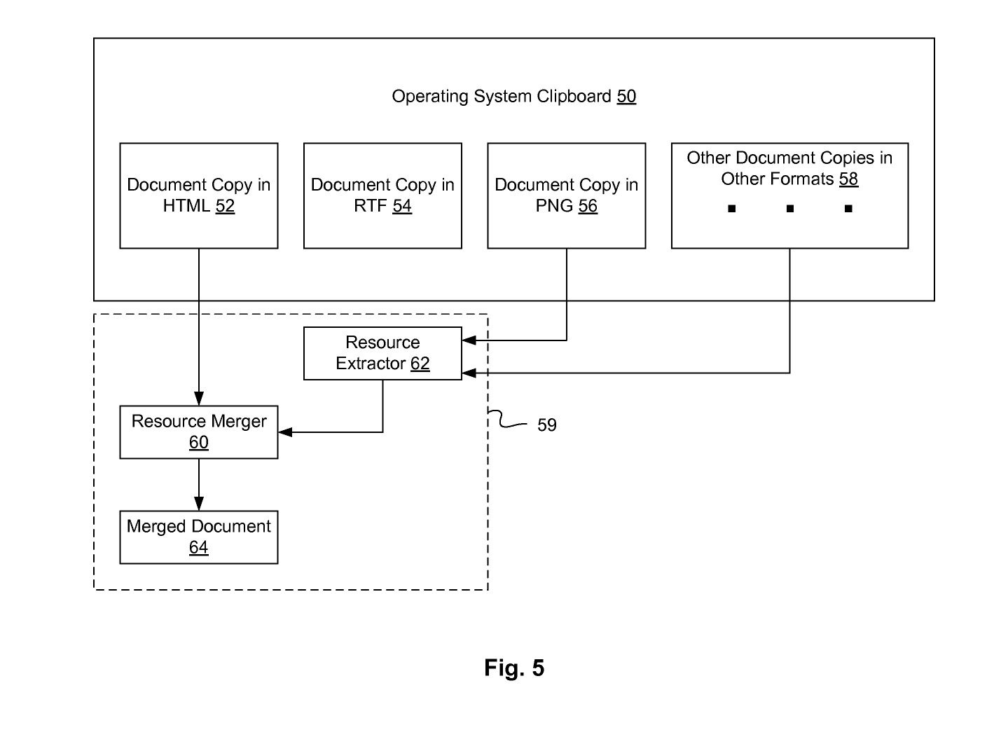

FIG. 5 illustrates a diagram of another embodiment for retrieving content from an operating system clipboard using document copies in multiple formats. In another embodiment, the resource extractor 62 extracts metadata and/or media content from the document copies 56 and 58 in the foreign formats. For instance, an image recognition method can be applied to the document copy 56 in the PNG format to determine if there is any image content present. If so, a listing of that image content is generated and passed to the resource merger 60 for merging of that image content. Other recognition software can also be applied on the document copy 56 to determine any metadata, embedded content, or any other content within the document copy 56.

The image recognition method (or other content recognition methods) can also be applied to the other document copy 58 to determine whether any image content is present in that document copy 58. This can be an optional step used for assessing the reliability of the image content detection from the document copy 56.

After determining if there's any image content, metadata, and/or other content information, the resource extractor 62 provides a list of resource descriptors for the document copy 56 and any extracted image content to the resource merger 60. The resource merger 60 can convert the extracted image content into the native format. The converted image content is inserted in the merged document 64 in place of the corresponding resource descriptors from the document copy 52.

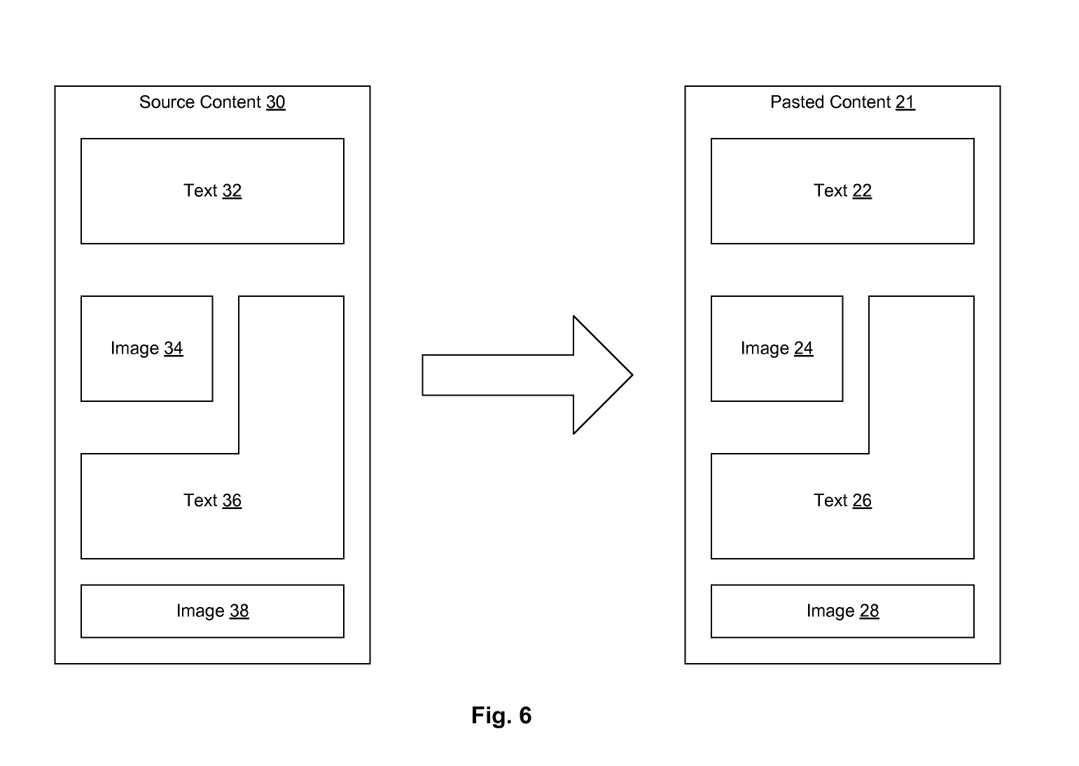

FIG. 6 illustrates a diagram where source content is pasted to a target application from an operating system clipboard. The selected source content 30 in the source application of the computing device can be cut (or copied) into the operating system clipboard 50. The source content 30 comprises text 32, image 34, text 36, and image 38. The source content 30 is copied into multiple formats in the operating system clipboard 50. The receiver 59 retrieves the source content 30 in the native HTML format. The receiver 59 will also retrieve the source content 30 in the RTF format to extract any embedded images or other embedded data/content.

Since embedded images of the source content 30 can be retrieved from one or more other document copies of the source content 30 in foreign formats, pasted content 21 can be displayed properly in the target application. Specifically, the image 34 and the image 38 are converted to images 24 and 28 in the HTML format using the one or more other document copies of the source content 30 in foreign formats. The text 32 and 36 can be pasted over to the pasted content to generate text 22 and text 26. The converted images 24 and 28 are merged with the text 22 and the text 26 to generate a merged document for display in the target application.

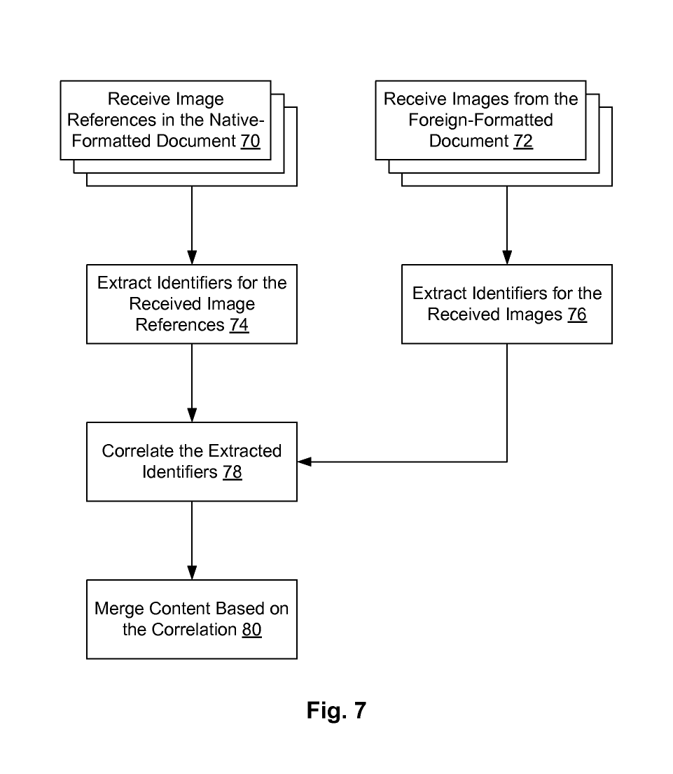

FIG. 7 illustrates a flow chart for implementing a resource merger using an identifier correlation method. A document copy in a native format can have image references (e.g., IDs, tags, URIs, etc.) for referencing image content. The image references in the native-formatted document copy can be received 70 by a resource merger. Identifiers for the received image references are extracted 74 from the native-formatted document copy. For instance, if the HTML format is the native format, then an image reference can have an image tag “<v:shape>” with an ID token “_x_{—}0000_<id>”. The image tag, the ID token, or both can be used to correlate the image reference with a corresponding image from a foreign-formatted document copy.

Images (including embedded image content and other image information) in the foreign-formatted document copy can be received 72. Any IDs for the received images can be extracted 76 from the foreign-formatted document copy. The extracted IDs from the native-formatted document copy and the extracted IDs from the foreign-formatted copy are correlated 78 to determine where the received images should be merged to in the native-formatted document copy to generate a merged document. Correlation can be performed by determining whether any of the extracted IDs from the native-formatted document copy match any of the extracted IDs from the foreign-formatted document copy. For instance, the alphanumeric strings for the extracted IDs from the native-formatted document copy and the alphanumeric strings for the extracted IDs from the foreign-formatted document copy are compared to each other to determine if there are any matches (or any similarities). If there is a match, then the corresponding image for the extracted ID from the foreign-formatted document copy can correspond to the extracted ID in the native-formatted document copy. The correlated images from the foreign-formatted document copy are merged 80 with any text content from the native-formatted document copy.

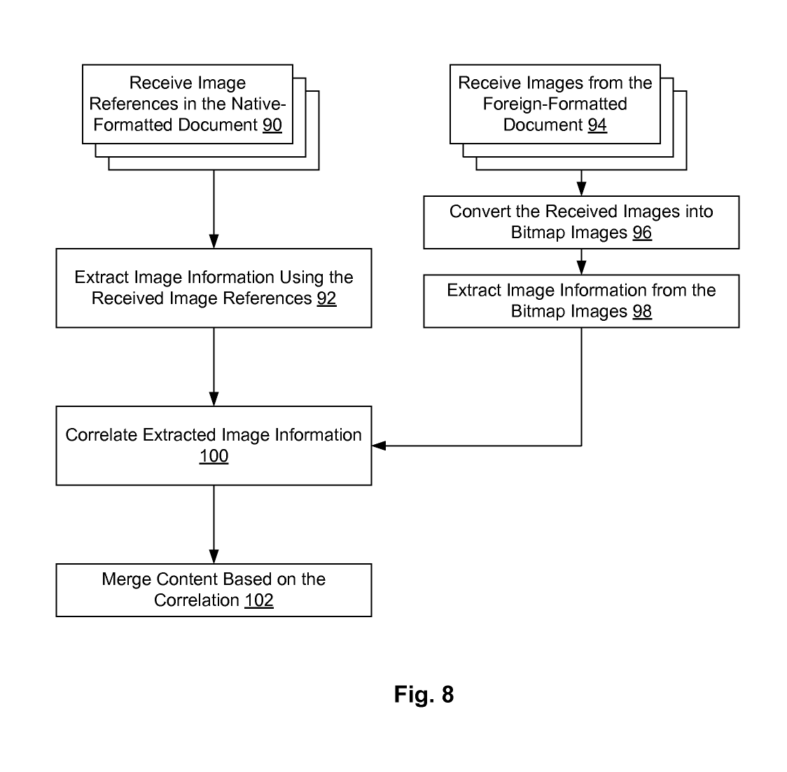

FIG. 8 illustrates a flow chart for implementing a resource merger using a metadata correlation method. A document copy in a native format can have image references (e.g., IDs, tags, URIs, etc.) for referencing image content. The image references in the native format can be received 90 by a resource merger. The native-formatted document copy 90 can have width, height, file extension, and/or other image information regarding the image content within the document. The image information and other metadata are extracted 92 from the native-formatted document copy using the received image references.

Embedded images from the foreign-formatted document copy are received 94. The received images are converted 96 into bitmap images. Image information, including width and height, metadata, and other image information, can be extracted 98 from the converted bitmap images. For instance, a bitmap image can be created in memory (or in another storage device) based on the embedded image content. Using that bitmap image, logic can determine the file format (e.g., JPEG, PNG, or other image format), width and height properties of the bitmap image, vertical and horizontal scale, metadata, and other image information for the embedded image content of the foreign-formatted document copy. The image information can be used to match the <img> tag of the native-formatted document copy based on relative image width and height attributes (or cascading style sheets values), file extension on the SRC attribute, etc.

The extracted image information from the native-formatted document copy and the extracted image information from the foreign-formatted document copy are correlated 100 to find matching image information. For any matching (or near matching) image information between the native-formatted document copy and the foreign-formatted document copy, the converted images are merged 102 with the native-formatted document copy by replacing the image references of the native-formatted document copy. The metadata correlation method can be used in place of or conjunction with one or more other correlation methods.

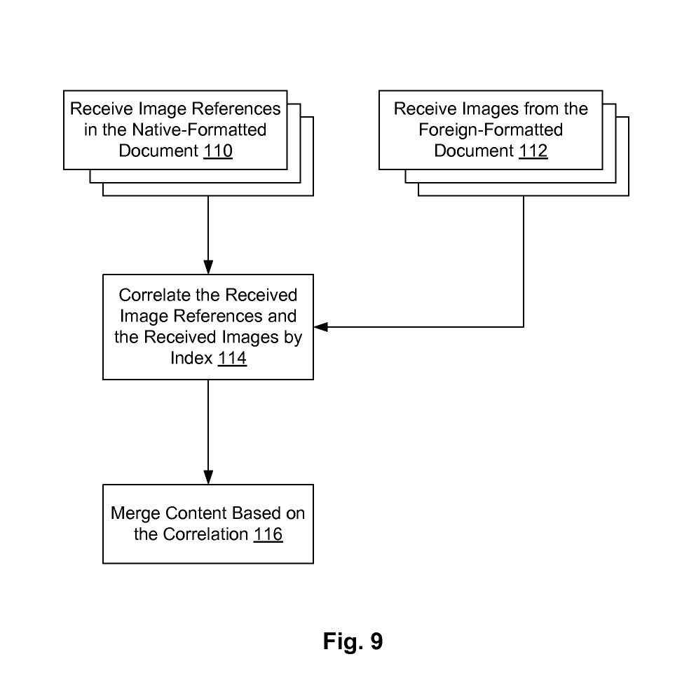

FIG. 9 illustrates a flow chart for implementing a resource merger using an order correlation method. For the order correlation method, image references from the native-formatted document copy are received 110. Likewise, embedded images from the foreign-formatted document copy are received 112. The received image references and the received images are correlated 114 to each other based on their respective order placement within their respective document. For instance, the first image tag in the native-formatted document copy corresponds to the first embedded image in the foreign-formatted document copy. Additionally, the second image tag (if any) in the native-formatted document copy corresponds to the second embedded image (if any) in the foreign-formatted document copy, and so on and so forth for any other image tags. Thereby, an image reference of the native-formatted document is replaced by the image with the same order placement in the foreign-formatted document. Thereby, the content of the native-formatted document copy and the images of the foreign-formatted document copy can be merged 116. The order correlation method can be used in place of or in conjunction with one or more other correlation methods.

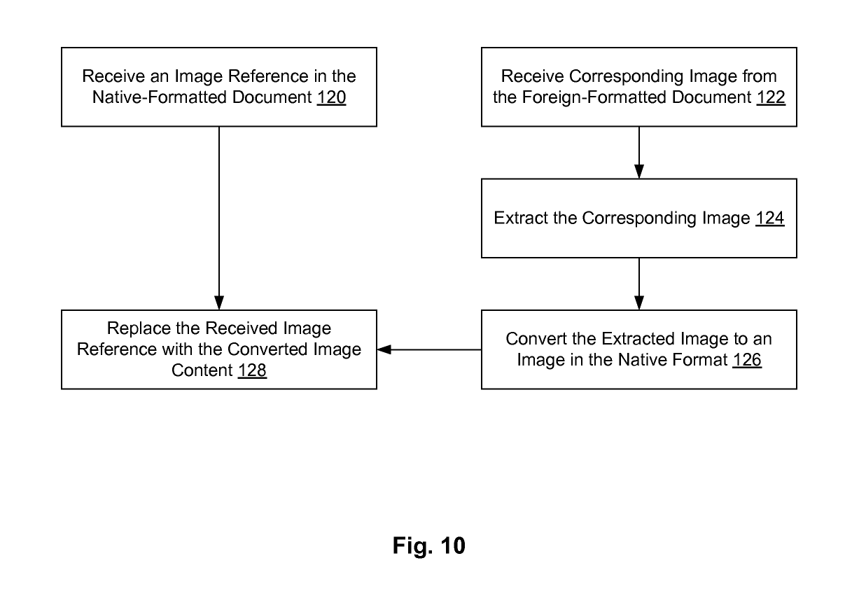

FIG. 10 illustrates a flow chart for merging image content using image references in a native-formatted document copy and embedded images from a foreign-formatted document copy. Merging can be performed by first receiving 120 an image reference in the native-formatted document copy. A corresponding image from the foreign-formatted document copy can also be received 122. The received image reference and the received corresponding embedded image are assumed to be correlated images. The embedded image is extracted 124 from the foreign-formatted document copy. The extracted image is converted to an image in the native format of the respective target application. For instance, if the extracted image content is to be converted to the HTML format, then the extracted image is converted 126 to either: (1) a base-64 encoded data-URI string; (2) a file that is uploaded to a remote webserver, whereby the target application has the appropriate rights to access the webserver for the image content; or (3) another HTML format. The received image reference is replaced 128 by the converted image. Thereby, the image content can be properly displayed in the target application.

While the disclosure has been described with reference to certain embodiments, it is to be understood that the disclosure is not limited to such embodiments. Rather, the disclosure should be understood and construed in its broadest meaning, as reflected by the following claims. Thus, these claims are to be understood as incorporating not only the apparatuses, methods, and systems described herein, but all those other and further alterations and modifications as would be apparent to those of ordinary skilled in the art.

We claim:

1. A method for generating a document for display in a target application, comprising the steps of:
retrieving document copies from an electronic clipboard, wherein the document copies are in multiple formats comprising at least a native format and a first foreign format;
extracting one or more objects from the retrieved document copy in the first foreign format;
merging the retrieved document copy in the native format and the extracted objects to generate a merged document; and
displaying the merged document in the target application.

2. The method of claim 1 wherein the multiple formats further comprise a second foreign format, and wherein one or more of the extracted objects are extracted from a document copy in the second foreign format.

3. The method of claim 1 wherein the extracted one or more objects are embedded image content of the retrieved document copy in the first foreign format.

4. The method of claim 3 wherein the merging step further comprising the substeps of:
extracting native image identifiers from the retrieved document copy in the native format;
extracting foreign image identifiers from the retrieved document copy in the foreign format;
correlating the extracted native image identifiers and the extracted foreign image identifiers; and
merging the embedded image content and the retrieved document copy in the native format as a function of the correlated identifiers.

5. The method of claim 3 wherein the merging step further comprising the substeps of:
converting the embedded image content into one or more converted images;
extracting foreign image information from the converted images;
extracting native image information from the retrieved document copy in the native format;
correlating the extracted foreign image information and the extracted native image information; and
merging the converted images and the retrieved document copy in the native format as a function of the correlated image information.

6. The method of claim 3 wherein the merging step further comprising the substeps of:
determining a native order of images in the retrieved document copy in the native format;
determining a foreign order of images in the retrieved document copy in the foreign format;
correlating the determined native order of images and the determined foreign order of images; and
merging the embedded images and the retrieved document copy in the native format as a function of the correlated order of images.

7. The method of claim 4 wherein in the merging the embedded image content and the retrieved document copy step, further comprising the substeps of:
extracting the embedded image content;
converting the extracted embedded image content to one or more converted images in the native format; and
replacing file references in the document copy in the native format with the converted images in the native format as a function of the correlated image identifiers.

8. The method of claim of claim 7 wherein the converted images in the native format are base-64 encoded data with universal reference indicator strings.

9. The method of claim 7 wherein the converted images are uploaded to a remote webserver and wherein the target application has rights to access the webserver to retrieve the converted images.

10. The method of claim 1 wherein the native format is a hypertext markup language format and the first foreign format is a rich text format.

11. A method for generating a document for display in a target application, comprising the steps of:
retrieving document copies from an electronic clipboard, wherein the document copies are in multiple formats comprising at least a native format and a first foreign format;
extracting one or more objects from the retrieved document copy in the first foreign format;
merging the retrieved document copy in the native format and the extracted objects to generate a merged document; and
displaying the merged document in the target application,
wherein the extracted one or more objects are embedded image content of the retrieved document copy in the first foreign format, and
wherein the native format is a hypertext markup language format and the first foreign format is a rich text format.

12. The method of claim 11 wherein the multiple formats further comprise a second foreign format, and wherein one or more of the extracted objects are extracted from a document copy in the second foreign format.

13. The method of claim 11 wherein the merging step further comprising the substeps of:
extracting native image identifiers from the retrieved document copy in the native format;
extracting foreign image identifiers from the retrieved document copy in the foreign format;
correlating the extracted native image identifiers and the extracted foreign image identifiers; and
merging the embedded image content and the retrieved document copy in the native format as a function of the correlated identifiers.

14. The method of claim 13 wherein in the merging the embedded image content and the retrieved document copy step, further comprising the substeps of:
extracting the embedded image content;
converting the extracted embedded image content to one or more converted images in the native format; and
replacing file references in the document copy in the native format with the converted images in the native format as a function of the correlated image identifiers.

15. The method of claim 11 wherein the merging step further comprising the substeps of:
converting the embedded image content into one or more converted images;
extracting foreign image information from the converted images;
extracting native image information from the retrieved document copy in the native format;
correlating the extracted foreign image information and the extracted native image information; and
merging the converted images and the retrieved document copy in the native format as a function of the correlated image information.

16. The method of claim 15 wherein in the merging the embedded images content and the retrieved document copy step, further comprising the substeps of:
extracting the embedded image content;
converting the extracted embedded image content to one or more converted images in the native format; and
replacing file references in the document copy in the native format with the converted images in the native format as a function of the correlated image information.

17. The method of claim 11 wherein the merging step further comprising the substeps of:
determining a native order of images in the retrieved document copy in the native format;
determining a foreign order of images in the retrieved document copy in the foreign format;
correlating the determined native order of images and the determined foreign order of images; and
merging the embedded images and the retrieved document copy in the native format as a function of the correlated order of images.

18. The method of claim 17 wherein in the merging the embedded image content and the retrieved document copy step, further comprising the substeps of:
extracting the embedded image content;
converting the extracted embedded image content to one or more converted images in the native format; and
replacing file references in the document copy in the native format with the converted images in the native format as a function of the correlated order of images.

19. A method for generating a document for display in a target application, comprising the steps of:
retrieving document copies from an electronic clipboard, wherein the document copies are in multiple formats comprising a native format and a first foreign format;
extracting one or more objects from the retrieved document copy in the first foreign format;
merging the retrieved document copy in the native format and the extracted objects to generate a merged document, comprising the substeps of:
extracting native image identifiers from the retrieved document copy in the native format;
extracting foreign image identifiers from the retrieved document copy in the foreign format;
correlating the extracted native image identifiers and the extracted foreign image identifiers; and
merging the embedded image content and the retrieved document copy in the native format as a function of the correlated identifiers, further comprising the substeps of:
extracting the embedded image content;
converting the extracted embedded image content to one or more converted images in the native format; and
replacing file references in the document copy in the native format with the converted images in the native format as a function of the correlated image identifiers; and
displaying the merged document in the target application,
wherein the extracted one or more objects are embedded image content of the retrieved document copy in the first foreign format,
wherein the native format is a hypertext markup language format and the first foreign format is a rich text format, and
wherein the converted images in the native format are base-64 encoded data with universal reference indicator strings.
